(19) United States
(12) Patent Application Publication
(10) Pub. No.: US 2007/0003053 A1
(43) Pub. Date: Jan. 4, 2007

(54) System and device for the remote powering of a data-processing device

(76) Inventors: Dean Mathoorasing, Moulineaux (FR); Didier Marquet, Malakoff (FR)

Correspondence Address: YOUNG & THOMPSON, 745 SOUTH 23RD STREET, 2ND FLOOR, ARLINGTON, VA, 22202, US

(21) Appl. No.: 10/571,784

(22) PCT Filed: Sep. 9, 2004
(86) PCT No.: PCT/FR04/02290

§ 371 Date: May 1, 2006

(30) Foreign Application Priority Data
Sep. 10, 2003 (FR) 0310872

(51) Int. Cl. H04M 9/00

(52) U.S. Cl. 379/413

(57) ABSTRACT

The invention relates to a system for the remote powering of at least one data-processing device (T) with determined power intensity and voltage operating ranges by means of a medium (8) for communication with a telecommunication network (6). The inventive system comprises an element (2) which transmits an information signal and an electric power signal to the at least one processing device (T), said power signal having a voltage and/or intensity greater than the maximum power intensity and/or voltage of said at least one processing device (T). The system further comprises a converter (18) with wide intensity and/or voltage input ranges, which is designed to receive the aforementioned electric power signal as input and to supply power having a voltage and intensity within the determined operating ranges of the at least one processing device (T, TIP, MHD). The invention also relates to the corresponding connection and conversion device.

The present invention relates to a system for the remote powering of at least one data-processing device having determined power intensity and voltage operating ranges and being connected, by a variable-length communication medium, to an element transmitting at least one electric power signal and at least one data signal originating from a telecommunication network.

The present invention also relates to corresponding connection and conversion devices.

Conventionally, data-processing devices are connected to telecommunication networks via transmitter elements, to which they are connected by variable-length communication media.

In the case of the switched telephone network used in France and known as the RTC Network, in particular, the data-processing devices, such as the telephones, are connected by a pair of twisted wires, the length of which varies, for example, from 0 to 8 km, to an operator centre forming the transmitter element, which is responsible for the exchanges of data with the RTC Network.

The telecommunication network, as defined above, thus corresponds to the devices forming what is commonly known as the “data transportation network”, and the communication medium corresponds to the devices forming what is commonly known as the “distribution network”.

In the remote powering of these devices, the transmitter elements comprise means for transmitting an electric power signal and means for coupling a data signal with the electric power signal in order to transmit the signals on the communication medium to the processing device.

The processing device, for its part, is connected to the communication medium by a connection device comprising suitable filtering means for separating the data and the electric power.

The RTC Public Network, for example, allows both a direct-current supply voltage of approximately 48 volts (V), capable of supplying a current of up to 60 milliamperes (mA), and analogue voice and control signals modulated in a bandwidth extending conventionally from 50 to 3,600 hertz to be conveyed, on a single pair of twisted wires, between the operator centre and the processing device.

The electric power signal transmitted by the transmitter element is limited by the capacity of the processing devices and, in particular, by the power intensity and voltage operating ranges of said element, which are conventionally defined by standards promoting a tolerance around nominal values.

Since the processing device is disposed at any distance from the transmitter element, the communication medium is variable in length such that the losses in the power signal are not predictable. Nevertheless, the device must never be supplied with a voltage or an intensity greater than the maximum values of its operating ranges, even if the length of the communication medium is very short.

The same problem occurs in other remote powering systems, such as the remote powering systems in local computer networks known as Power-on-LANs, in which the intensity and voltage of the transmitted electric power is limited by the maximum tolerances of the devices, which may be disposed at variable distances and therefore receive an electric power signal with variable losses.

It has, however, been found that the electric power requirements in the processing devices exceed the capacities of the remote powering systems.

Moreover, the communication media are frequently used for transporting different types of data to a plurality of different processing devices.

The transmitted power signal is then limited by the lowest maximum power intensity and voltage values of all of the connected processing devices, such that the electric power that is transmitted is often insufficient for powering even a single device.

The processing devices therefore require external electric power sources such as a three-phase power network.

However, external sources supplying electric energy are not always reliable and may be expensive or else not available at all times.

Thus, in existing remote powering systems, the electric power that is transmitted allows only a limited number of transmitted data items to be processed, the processing of other items being dependent on external sources supplying electric energy.

The object of the present invention is to overcome this problem by defining a remote powering system and corresponding connection and conversion devices allowing the transmitted data to be processed independently of an external electric power source.

The invention accordingly relates to a system for the remote powering of at least one data-processing device having given power intensity and voltage operating ranges and being connected, via a variable-length communication medium, to a transmitter element comprising means for exchanging at least one data signal with a telecommunication network, means for transmitting an electric power signal to said at least one device, means for coupling said at least one data signal exchanged with said network to said at least one electric power signal for the transmission thereof, on said communication medium, to a connection device of said at least one processing device, said connection device comprising filtering means suitable for separating said electric power data signals, characterised in that said means for the transmission of an electric power signal are suitable for transmitting an electric power signal having an intensity and/or a voltage greater than the maximum power intensity and/or voltage of the corresponding ranges of said at least one processing device, and in that the system comprises a power converter having wide intensity and/or voltage input ranges, which converter is inserted on said communication medium, between said transmitter element and said data-processing device, for defining a first medium for communication between said transmitter element and said converter and a second medium for communication between said converter and said processing device, said converter being suitable for receiving said electric power signal transmitted by the transmitter element and for delivering an electric power signal having a suitable intensity and voltage to allow for the power losses caused by said second communication medium in order to supply said at least one processing device with power having an intensity and a voltage within its given operating ranges.

The system of the invention thus allows an electric power signal to be delivered, via the communication medium, to the processing device so as to ensure that said device operates correctly and within its intensity and voltage limits.

According to other characteristics of the invention:
said converter is inserted on said communication medium between said filtering means of said connection device and said at least one processing device, to which it is connected directly by said second communication medium;
said converter is inserted on said communication medium between said transmitter element and said filtering means of the connection device, said converter being connected to said first communication medium via a filtering unit in order to separate said data signal and said electric power signal, and being connected to said second communication medium by a suitable coupling unit on said second medium in order to transmit said data signal and said electric power signal;
said transmitter element is suitable for transferring a unique signal containing one or more types of data, said converter being suitable for powering a device for processing at least one of said types of data;
said transmitter element is suitable for transferring at least two signals, each containing one or more types of data, said filtering means being suitable for delivering a different signal to each corresponding processing device, and said converter being suitable for powering at least one device for processing one of said types of data;
said transmitter element is suitable for transferring at least one signal containing digital data, and said filtering means of the connection device deliver at least one signal containing digital data to a high-speed communication device forming the processing device and another signal containing said received electric power to said converter, which is suitable for powering at least said high-speed communication device;
said high-speed communication device is connected to at least one other processing device for transmitting thereto all or some of said digital data, and said converter is suitable for powering said high-speed communication device and also at least one other processing device;
said transmitter element is suitable for transferring at least one signal containing analogue voice data mixed at a so-called nominal electric power, said means for transmitting an electric power signal being suitable for transmitting a so-called additional electric power signal, and said filtering means of the connection device delivering a signal containing said analogue voice data, mixed at said nominal electric power, to a telephone device forming the processing device, and another signal, containing said additional electric power, to said converter;
it also comprises means for detecting the presence of a data signal on said communication medium so as to reduce the transmission of said additional electric power when a data signal is detected on said communication medium, in order to allow the transmission, sequentially over time, of said at least one data signal and said additional electric power;
said transmitter element and said connection device each comprise a controllable switch module for connecting to said communication medium, which modules are controlled by said line tap-detection means, for respectively switching, in said transmitter element, between said at least one data signal and said additional electric power signal and, in said connection device, between said data-processing device or devices and said converter, so as to allow, alternately, the transfer, on said communication medium, of said at least one data signal to the processing device or devices or the transfer of said additional electric power signal to said converter;
said transmitter element comprises controllable means for simulating a line tap, which means are connected to the output of the data exchange means and to the input of said coupling means, which are suitable for not transferring said nominal electric power originating from said transmitter element to said communication medium, and said connection device comprises a controllable switch module for connecting said converter to said communication medium, said line tap-simulation means and said controllable switch being controlled by said line tap-detection means for simulating, in said data transfer network, the line tap, and for limiting the electric power circulating on said communication medium during a line tap;
said converter is suitable for directly delivering a plurality of electric power signals, each intended for a different processing device, each electric power signal having a suitable intensity and voltage to allow for the power losses caused by said second communication medium, in order to supply to each processing device power having an intensity and a voltage within its given operating ranges;
it also comprises means for driving said converter, which means are suitable for driving it as a function of the nature of the data supplied by said filtering means for delivering an electric power signal suitable for the device for processing this data;
it comprises electric energy storage means suitable for receiving all or some of the electric power conveyed on said communication medium and for adjusting the supply of electric energy to said converter;
said connection device is provided for being connected to at least one processing device selected from a group consisting of a wireless radio-wave communication device, a high-speed modem and a device for communication with a mobile telephone.

The invention also relates to a device for connecting to a communication medium, with a telecommunication network of at least one processing device having given power intensity and voltage operating ranges, the device comprising suitable filtering means for separating at least one data signal and an electric power signal conveyed by said communication medium, characterised in that it also comprises a converter having wide intensity and/or voltage input ranges, which converter is suitable for receiving at its input an electric power signal having an intensity and/or a voltage greater than the maximum power intensity and/or voltage of said at least one processing device, and for supplying power having an intensity and a voltage within the given operating ranges of said at least one processing device.

The invention further relates to a power conversion device inserted on a communication medium, between a transmitter element and a data-processing device, for defining a first communication medium between said transmitter element and said conversion device, and a second communication medium between said conversion device and said processing device, said device being connected to said first communication medium via a filtering device, in order to separate data and electric power signals, and being connected to said second communication medium by a coupling unit, in order to transmit said data signals and a suitable electric power signal, characterised in that it comprises a converter having wide intensity and/or voltage input ranges, between said filtering unit and said coupling unit, which converter is suitable for receiving at its input an electric power signal having an intensity and/or voltage greater than the maximum power intensity and/or voltage of said at least one processing device, and for supplying power having an intensity and a voltage within the given operating ranges of said at least one processing device.

A better understanding of the invention will be facilitated by reading the following description, given solely by way of example and with reference to the accompanying drawings, in which:

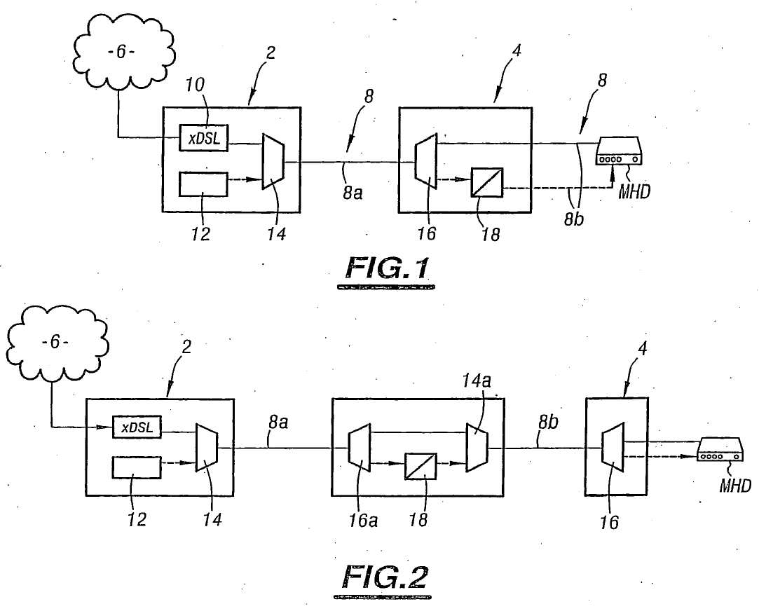

FIGS. 1 to 5 are block diagrams illustrating in a general manner various embodiments of the invention;

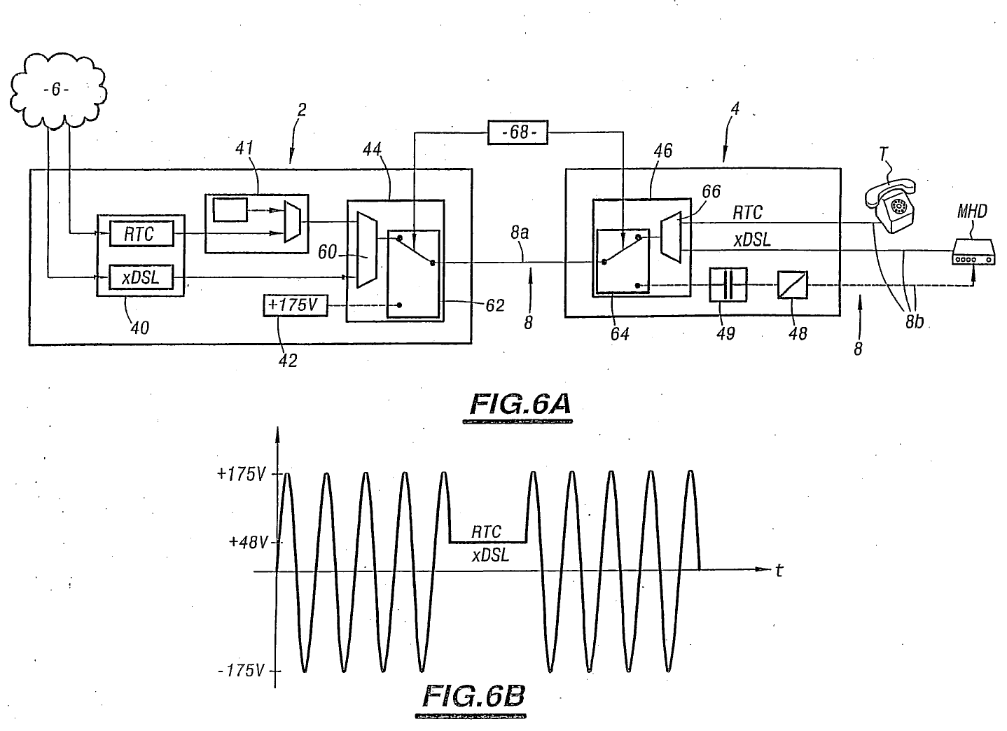

FIG. 6a and 6b illustrate a detailed embodiment of the system of the invention as described with reference to FIG. 5; and

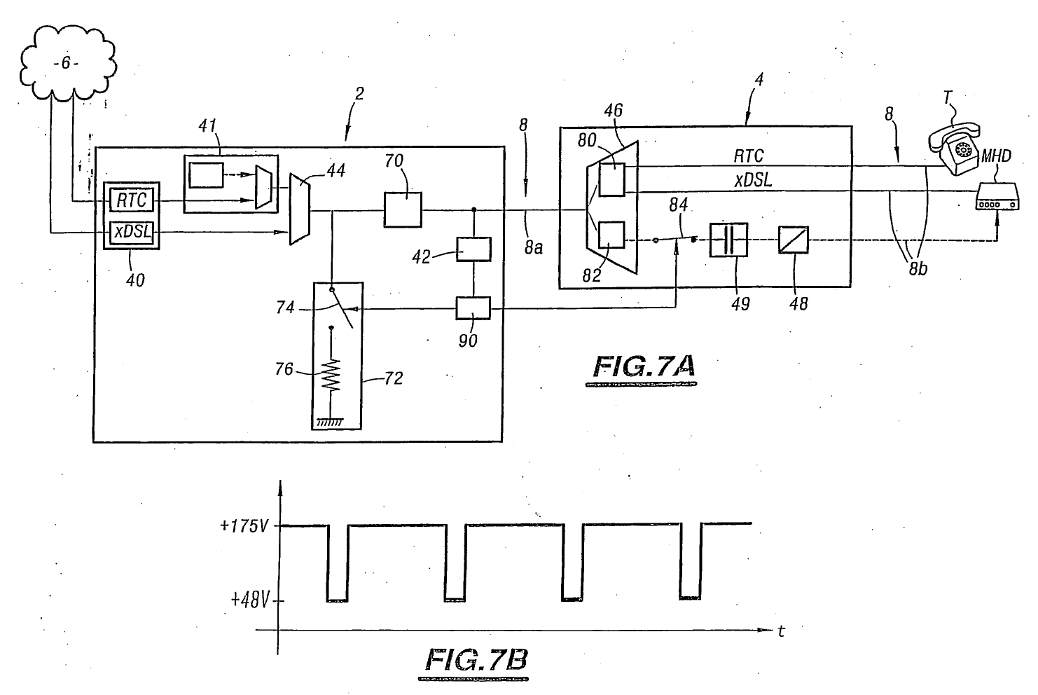

FIG. 7a and 7b illustrate another detailed embodiment of the system of the invention as described with reference to FIG. 5.

FIG. 1 illustrates a general embodiment of a system according to the invention.

The illustrated system comprise a transmitter element 2 allowing data and power signals to be transmitted to a connection device 4 for at least one processing device consisting of a high-speed communication device such as, for example, an xDSL modem, designated MHD.

Conventionally, the processing device MHD has given power intensity and voltage operating ranges defining maximum power intensity and voltage values such as, for example, 12 volts (V) and 60 milliamperes (mA).

The processing device MHD is connected to a telecommunication network 6 consisting, in the example, of an xDSL-type digital data transportation network. The telecommunication network 6 is taken to be what is commonly known as a “data transportation network” consisting, for example, of optical loops and associated devices.

The transmitter element 2 and the connection device 4 are conventionally connected via a transmission medium 8 consisting, for example, of a pair of twisted copper wires having a total length varying from 0 to 8 km.

This communication medium 8 forms what is commonly known as a “distribution network” and comprises one or more sections interconnected by suitable devices such as switch modules and automatic switch modules.

In the embodiment illustrated with reference to FIG. 1, the transmitter element 2 comprises means 10 for exchanging a high-speed data signal, for example an xDSL-type signal, with the network 6.

This transmitter element 2 also comprises means 12 for transferring an electric power signal and coupling means 14 allowing the transmission, on the twisted pair 8, of the xDSL signal and the electric power signal.

According to the invention, the electric power signal transmitted by the means 12 is a signal having an intensity and/or a voltage greater than the maximum operating intensity and/or voltage of the device MHD.

In particular, the electric power signal that is transmitted has an intensity and/or a voltage greater than double the maximum operating intensity and/or voltage of the processing device MHD.

The device 4 correspondingly comprises filtering means 16 made in a conventional manner and suitable for delivering a first signal containing the xDSL-type data and a second signal containing the electric power.

Moreover, the system also comprises an electric power converter 18, which has wide intensity and voltage input ranges and is inserted on said communication medium 8 between the transmitter element 2 and the device MHD.

A converter having wide input ranges is a converter suitable for delivering one or more constant-intensity and/or voltage output signals on the basis of an input varying within a wide range, for example a voltage input varying between 0 and 300 volts.

A converter of this type advantageously includes elements for the temporary storage of electric energy in order to provide one or more output signals even if there is no power at the input for a given period.

Such converters are conventional in the field of the transportation of electric energy.

The converter 18 thus defines a first medium 8a for communication between the transmitter element 2 and the converter 18, and a second medium 8b for communication between the converter 18 and the processing device MHD.

Said converter 18 is suitable for receiving said electric power signal transmitted by the transmitter element 2 and for delivering an electric power signal having a suitable intensity and voltage to allow for the power losses caused by the second communication medium 8b in order to supply the processing device MHD with power having an intensity and a voltage within the given operating ranges.

In the described embodiment, the converter 18 is inserted directly into the communication device 4, between the filtering means 16 and the processing device MHD.

The second medium 8b for transportation between the converter and the processing device MHD is thus set apart by merely a few metres, such that the losses caused are very low.

The electric power signal delivered by the converter 18 therefore has an intensity and a voltage equal to or less than the maximum power intensity and voltage of the device MHD.

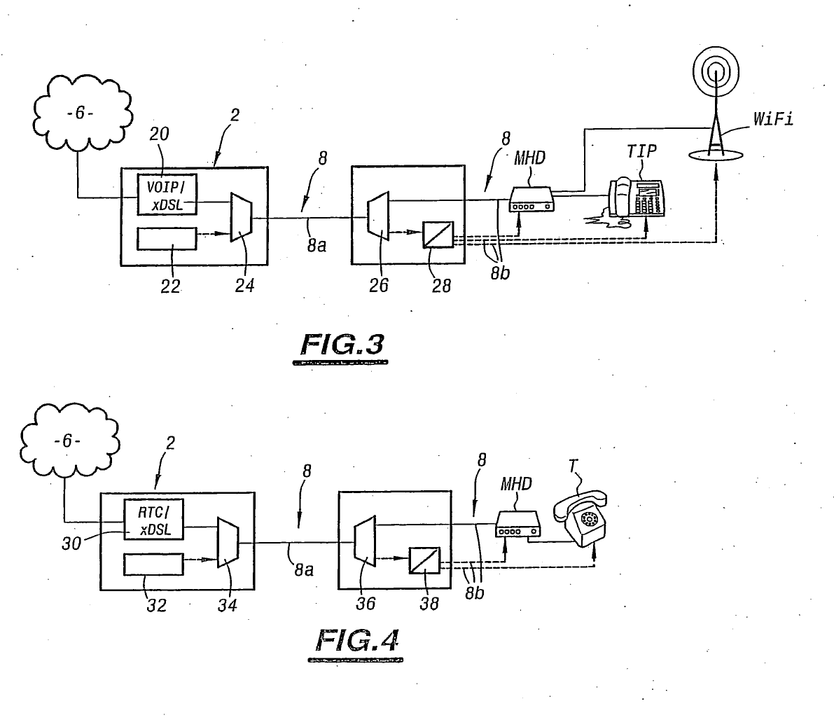

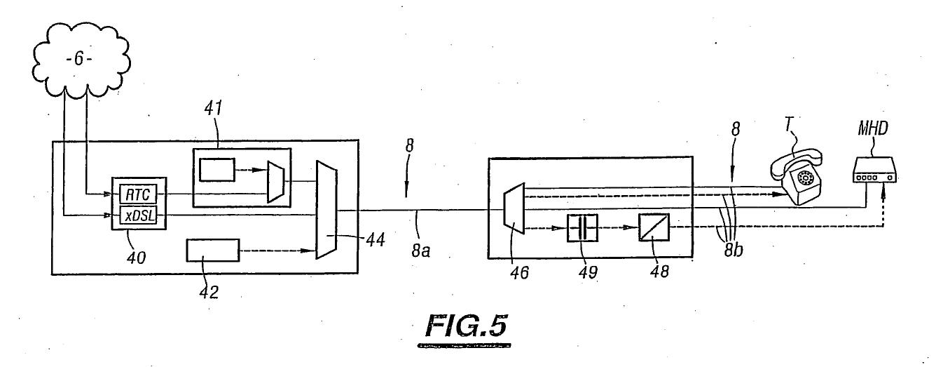

The electric power supplied by the converter 18 is advantageously used, as will be described in greater detail with reference to FIG. 3, for powering another data-processing device.

The described system thus allows a signal containing data, such as high-speed data and the electric power required for powering a device for processing this data, to be transmitted in a conventional manner on the communication medium 8.

A second embodiment of the system described with regard to FIG. 1 will be described with reference to FIG. 2, in which embodiment the converter 18 is inserted between the transmitter element 2 and the processing device MHD, separately from the connection device 4.

In this case, the converter 18 is disposed at an arbitrary location in the communication medium 8 and is integrated into a conversion device 19.

The converter is connected to the first communication medium 8a via a filtering unit 16a, similar to the filtering means 16, in order to separate the data signal and the electric power signal.

It is also connected to the second communication medium 8b by a coupling unit 14a, similar to the coupling means 14, in order to transmit the data signals and the suitable electric power signal.

In this embodiment, the intensity and voltage levels at the output of the converter have to take account of the length of the second communication medium 8b connecting the converter to the connection device and therefore to the processing device MHD, in order to allow for the resultant losses.

The converter thus delivers, directly at its output, an electric power signal having an intensity and/or a voltage greater than the maximum power intensity and/or voltage levels of the processing device MHD.

These intensities and/or voltage levels are adapted to the losses caused by the second communication medium 8b, in order to supply power having an intensity and a voltage within the given operating ranges of the processing device MHD.

The converter 18 advantageously comprises adjustment means in order to allow the output intensity and/or voltage levels to be adapted, by an operator or an automatic system, to the length of the second communication medium 8b.

Another embodiment of the invention will be described with reference to FIG. 3.

In this embodiment, the transmitter element 2 comprises means 20 for exchanging a signal containing first data transmitted simultaneously to second data.

A signal of this type consists, for example, of digital voice data frames formed according to the Voice-Over-Internet Protocol, or VOIP for short, and high-speed digital data according to the xDSL protocol.

The exchange means 20 are, for example, suitable for multiplexing this data, by amplitude, by frequency, by phase or else over time.

The transmitter element 2 also comprises means 22 for transferring an electric power signal, which means are suitable for supplying an electric power, and means 24 for coupling the data signal and the electric power signal in order to transmit these signals on the twisted pair 8.

The electric power signal transmitted by the means 22 is, as was the case above, at an intensity and/or a voltage greater than the maximum power intensity and/or voltage of the connected processing devices.

The connection means 4 comprises suitable filtering means 26 for delivering a data signal containing the first and second data and a signal containing the electric power.

The data signal delivered by the filtering means 26 is transmitted to a high-speed modem MHD capable, in particular, of retrieving therefrom the digital voice data in order then to transmit it, for example, to a telephone operating according to the Voice-Over-IP, known as the Telephone-Over-IP and designated TIP, or else to a WiFi-type wireless radio-wave receiver/transmitter antenna.

The electric power signal delivered by the filtering means 26 is transmitted to a converter 28 having wide input ranges.

In this embodiment, the converter 22 is suitable for delivering at its output a plurality of electric power signals, each allocated to a different processing device. The various electric power signals have an intensity and a voltage adapted to the length of the communication medium 8b connecting the converter 22 to each device in order to exceed neither their maximum power intensity nor their maximum voltage.

The converter thus delivers at its output a first power signal allocated to the modem MHD, a second power signal allocated to the Telephone-Over-IP TIP, and a third power signal allocated to the WiFi antenna.

In the described embodiment, the second communication medium 8b connecting the converter 18 to each device MHD, TIP and WiFi has a length of merely a few metres.

The converter 18 is therefore connected directly to each of the various processing devices, such that each power signal has an intensity and a voltage lower than the maximum power intensity and voltage of each device, respectively.

It may therefore be seen that the system of the invention allows a plurality of types of data and sufficient electric power for the operation of a plurality of different corresponding processing devices to be conveyed on a single communication medium 8.

FIG. 4 illustrates another embodiment of the invention.

In this embodiment, the transmitter element 2 comprises means 30 for transferring a signal containing first analogue voice data according to the RTC Standard, which data is inserted into xDSL-type high-speed digital data.

As was the case above, the element 2 comprises means 32 for transferring an electric power signal and means 34 for coupling the data signal and the electric power signal for the transmission thereof on the medium 8.

The connection device 4 comprises, for its part, filtering means 36, which deliver a first signal containing the data intended for a high-speed modem MHD, which is suitable for separating the information data and the voice data and for transmitting the voice data to a telephone T.

The filtering means 36 also deliver a second signal containing all of the electric power that is received, and transmit it to a converter 38, which has wide input ranges and is suitable for powering the modem MHD and the telephone T.

The modem MHD decodes the high-speed digital data frames to retrieve therefrom the analogue voice data and to transmit it to the telephone T, which is also powered by the converter 48.

In a variation, the modem MHD may separate the analogue voice data and mix it with the electric power received from the converter 48 so as directly to form an RTC-type telephone signal, in order to transmit to the telephone T the voice data and electric power combined.

In this embodiment, the telephone is therefore powered by the electric power signal, which is transmitted by the means 32 and is delivered to the telephone T indirectly via the modem MHD.

The system may, of course, operate in an equivalent manner with other types of data and, in particular, the modem MHD may reconstruct an RTC-type signal from voice data received, for example, in Internet format, known as IP format.

Another embodiment of the invention will now be described with reference to FIG. 5.

In this embodiment, the telecommunication network 6 is suitable for the transmission of a plurality of different data signals.

In the described example, these signals consist of a signal containing analogue voice data according to the RTC Standard and of an xDSL-type high-speed data signal, and the transmitter element 2 comprises means 40 for exchanging these various data signals with the network 6.

Conventionally, the transmitter element 2 also comprises means 41 for generating an RTC-type signal, which means consist of a unit transmitting an electric power having a direct-current voltage of approximately 48 volts and capable of supplying up to 60 milliamperes, and of a unit for analogically coupling this electric power with the data signal for forming a signal according to the RTC Standard. This electric power is known as the nominal electric power.

The transmitter element 2 also comprises means 42 for transmitting an electric power signal, an intensity and/or a voltage greater than the maximum intensity and/or the maximum voltage of the connected processing devices, and coupling means 44 suitable for transmitting the RTC-type signal, the xDSL-type signal and the electric power signal on a single medium 8. This electric power is known as the additional electric power.

The connection device 4 comprises, for its part, suitable filtering means 46 for delivering a first RTC-type signal, containing the analogue voice data and the nominal electric power, to a telephone T, and a second signal containing the xDSL-type data intended for a high-speed communication device MHD.

The filtering means 46 also deliver a third signal containing the additional electric power transmitted to a converter 48 having wide input ranges.

This converter 48 is, in particular, suitable for electrically powering the modem MHD for processing the xDSL-type data.

Nevertheless, in the transmission of an RTC-type signal, the analogue voice data is mixed at the direct-current nominal electric power of 48 volts. According to this standard, it is necessary to know the amount of nominal electric power consumed in order to establish communications.

The detection of a line tap, corresponding to the picking-up of a receiver, is based on the detection of a reduction in voltage on the medium 8.

In order to allow such detection, the transmitter element 2 is suitable for transmitting the additional electric power, in a discontinuous manner over time, so the communication medium 8 momentarily conveys only the RTC-type signal, optionally combined with the xDSL-type signal.

Momentarily, no additional electric power is therefore transmitted on the medium 8.

In order to compensate such discontinuous powering, the converter is preceded by electric energy storage means 49, to allow regulation of these interruptions in the transmission of electric power.

The embodiment illustrated in FIG. 5 will now be described in detail with reference to FIG. 6A.

The system illustrated in FIG. 6A comprises the transmitter element 2 and the connection device 4, both of which are connected via the twisted pair 8.

The connection device 4 is connected to the telephone T and to the high-speed communication device MHD.

The signal exchange means 40, which, as has been described above, are suitable for exchanging with the network 6 a first RTC-type signal containing analogue voice data and a second xDSL-type high-speed digital data signal, may be seen from this FIG. 6A.

These exchange means are followed by means 41 for generating the RTC-type signal, as described above.

The transmitter element 2 also comprises the means 42 for transferring the additional electric power signal, which means consist, in the described example, of an element for the sinusoidal supply of approximately 175 volts, i.e. 350 volts peak to peak, and capable of supplying up to 60 milliamperes of current.

The coupling means 44 comprise a coupler 60 made in a conventional manner and suitable for coupling the RTC-type analogue voice data and the xDSL-type information data to a single signal.

Moreover, the coupling means 44 comprise a switch module 62, which is suitable for remote control and for connecting the output of the transmitter element 2, which is connected to the twisted pair 8, either to the output of the coupler 60 delivering the combined data signals or to the means 42 for transferring an additional power signal supplying a sinusoidal voltage of approximately 175 volts.

Similarly, the connection device 4 comprises, in the filtering means 46, a switch module 64, which is suitable for remote control and for connecting the input of the connection device 4, which is connected to the twisted pair 8, either to a filtering element 66 or to the electric energy storage means 49.

The filtering element 66 is suitable for separating, in a single signal, the RTC-type analogue voice data and the xDSL-type high-speed information data, a filtering element of this type being made in a conventional manner.

The means 49 consist, in the described embodiment, of a rechargeable battery, which is recharged solely by the additional electric power transmitted by the means 42.

The filtering means 46 therefore deliver, as was described with reference to FIG. 4, a first RTC-type signal to the telephone T, a second xDSL-type signal to the high-speed modem MHD, and a third signal, containing the additional electric power, to the energy storage means 49.

The electric energy storage means 49 are connected to the converter 48, which powers the modem MHD so as to ensure its operation by delivering an electric power signal, the intensity and voltage of which do not exceed its maximum power intensity and voltage.

Finally, the system comprises means 68 for detecting the presence of a data signal on the twisted pair 8, which means are connected to the controllable switch modules 62 and 64, so the additional electric power signal is transmitted on the twisted pair 8 only if there is no data signal.

The operation of this system will now be described with reference to FIG. 6A and 6B.

In a first operating phase, assuming that there is no data signal on the twisted pair 8, the detection means 68 control the switch modules 62 and 64 in such a way that the means 42 for transferring an additional power signal are connected directly to the electric energy storage means 48 in order to power them. The twisted pair 8 thus conveys only the additional electric power signal in the form of a sinusoidal signal of 350 volts peak to peak, as illustrated in FIG. 6B.

In a second operating phase, the means 68 for detecting a data signal detect a line tap preceding the transmission of an RTC-type analogue voice signal or an xDSL-type digital data signal. This line tap may be initiated by the transmitter element 2 or by a processing device connected to the connection device 4.

During this detection, the means 68 control the switch modules 62 and 64 so as to connect the means 40 for exchanging data signals to the telephone T or to the modem MHD via the medium 8.

The switch module 62 thus connects the output of the coupler 60 to the twisted pair 8 in such a way that this twisted pair 8 conveys the RTC signal containing the analogue voice data and the associated nominal electric power of 48 volts and/or the xDSL-type information data.

The switch module 44 correspondingly connects the twisted pair 8 to the filtering means 46, which means are suitable for delivering at their output the RTC signal, which is transmitted to the telephone T, and the xDSL-type high-speed data signal, which is transmitted to the modem MHD.

During this second operating phase, the telephone T is powered, at least in part, by the nominal electric power transmitted with the analogue voice data according to the RTC Standard. The modem MHD, for its part, is powered solely by the converter 48, which is connected to the electric energy storage means 49, to ensure the operation thereof owing to the previously transmitted and stored additional electric power.

The associated voice data, the nominal electric power and/or the information data are therefore transmitted sequentially over time with the additional electric power on a single communication medium formed by the twisted pair 8.

It may therefore be seen that the described system allows analogue voice data, information data, a nominal electric power and an additional electric power to be transmitted on a single data medium, for processing voice and information data.

A second detailed embodiment of the invention as illustrated with reference to FIG. 5 will now be described with reference to FIG. 7A.

As was the case above, the means 40 for exchanging data signals and 41 for generating an RTC-type signal, which means are suitable for transmitting an RTC-type signal containing analogue voice data mixed at a nominal electric power and a second xDSL-type high-speed analogue data signal, may be seen in this figure.

In this embodiment the RTC-type signal and the xDSL-type signal are mixed together in a conventional manner by the coupling means 44 in such a way that the signals are followed by a unique signal containing all of the xDSL-type and RTC-type data, as well as the nominal power of 48 volts corresponding to the RTC Standard.

The output of these coupling means 44 is connected to a decoupling unit 70 consisting, for example, of a capacitor, in such a way that only alternative components of the input signals are delivered at the output of this decoupling unit 70, the direct-current voltage component of 48 volts being eliminated.

The output of the decoupling unit 70 is connected to the means 42 for transferring an additional electric power signal and is connected directly to the communication medium 8.

The decoupling unit 70 thus forms the coupling means as denoted in FIG. 5 under reference numeral 44.

In the described embodiment, the means 42 for transmitting an electric power signal are suitable for the transmission of a signal in the form of a direct-current square-wave voltage, alternating between +175 volts and +48 volts, as illustrated with reference to FIG. 7B.

Moreover, the transmitter element 2 comprises line tap-simulation means 72, inserted between the coupling means 44 and the decoupling unit 70.

These simulation means 72 consist, in the described embodiment, of a controllable switch 74 in series with a resistor 76 connected to a mass.

Switching off the controllable switch 74 thus causes a current to flow in the resistor 76 toward the mass, causing a voltage drop and simulating a line tap.

In the connection device 4, the filtering means 46 consist of a high-pass filter 80 and a low-pass filter 82, disposed in parallel.

The output of the high-pass filter 80 allows the data signals to be obtained directly and is connected to the processing devices MHD and T.

The output of the low-pass filter 82, for its part, is connected to a controllable switch and, in series, to the energy storage means 49 and to a converter 48.

Thus, only the electric power signals circulate between the low-pass filter 82 of the filtering means 46 and the converter 48.

The output signals of the converter 48 are then delivered to the processing devices MHD and T, to power said devices.

Advantageously, the converter 48 delivers a plurality of different output signals at intensity and voltage levels adapted to the length of the second communication medium 8b, which connects the converter to the processing devices MHB and T. It thus delivers electric power signals having an intensity and voltage lower than the maximum power intensity and voltage of each of the devices, while at the same time transmitting sufficient electric power to ensure the operation of said devices.

Finally, the system comprises line tap-detection means 90, which are connected to the two controllable switches 74 and 84 and consist, in the described embodiment, of means for monitoring the current circulating on the first communication medium 8a. These line tap-detection means 90 are integrated into the transmitter element 2.

During operation, the unit 70 for decoupling the transmitter element 2 receives at its input the RTC-type and xDSL-type multiplexed signals.

It delivers at its output the mere alternative components of these signals, having eliminated the direct-current nominal power component of 48 volts.

These data signals are then combined with the additional power signal delivered by the means 42 via a single connection as defined above.

It may therefore be seen that the first communication medium 8a conveys alternative signals, corresponding to portions of the RTC and xDSL signals, and an additional electric power square-wave signal.

More particularly, the xDSL-type signal is transmitted in its entirety, while merely the voice and bell components of the RTC signal are transmitted.

In a first operating phase, the system is such that the switch 74 of the line tap-simulation means 72 is switched on, while the switch 84 of the connection device 4 is switched off.

The filtering means 46 receive the combined signals and separate, using the high-pass filter 80, the data signals, which are transmitted directly to the modem MHD and/or to the telephone T.

The data conveyed by the xDSL and the RTC signals is thus continuously transmitted between the processing devices MHD and T and the telecommunication network 6.

The high-pass filter 80 advantageously also fulfils a voltage-limitation function, in order to transmit to the devices only voltage levels less than or equal to their maximum supply voltage. A maximum voltage of 48 V is thus conveyed by the connection between the high-pass filter 80 and the telephone T.

The filtering means 46 also separate, using the high-pass filter 82, the additional electric power signal, which is transmitted to the storage means 49, then to the converter 48, which directly delivers supply signals, in particular for the processing device MHD.

In this operating phase, the telephone T requires no power, while the modem MHD is powered by the converter 48, which delivers an electric power signal adapted to the length of the second communication medium 8b, in order not to exceed the maximum power intensity and voltage thereof.

In a second operating phase, the telephone T is picked up once a bell signal has been received, or spontaneously, to effect a line tap. The value of the current circulating on the communication medium 8 is modified by this line tap, which corresponds to a variation in the resistance of the telephone.

The line tap is detected only when the voltage of the additional electric power signal is at its low level, corresponding to nominal voltage of the RTC signal; the line tap therefore results in a zero current during these intervals.

The line tap-detection means 90 then control the controllable switches 74 and 84 in order to switch off the controllable switch 74 of the line tap-simulation means 72 and to switch on the controllable switch 84 of the connection device 4.

Switching off the controllable switch 74 of the line tap-simulation means 72 allows the line tap to be simulated at the level of the intensity and the voltage of the RTC signal in order to allow this line-tap data to be transmitted, in a conventional manner, to the telecommunication network 6.

Switching on the controllable switch 84 of the connection device 4 allows the loading of the storage means 49 to be interrupted so as to prevent the circulation, on the communication medium 8, of a current likely to disrupt the transmission of the RTC-type data.

During this operating phase, the telephone T is powered, at least in part, owing to the nominal electric power of 48V transmitted by the means 42 and filtered by the high-pass filter 80, as indicated above.

Advantageously, the telephone T also receives further electric power from the converter 48.

Moreover, the modem MHD is powered solely by the converter 48, which transforms the energy stored by the storage means 49 for delivering an electric power signal adapted to the length of the second communication medium 8b.

It may therefore be seen that this embodiment facilitates the operation of the remote powering system of the invention, while at the same time allowing the transmission of the data.

In some cases, the telephone T comprises variable means for the amplification of the voice signal. These amplification means are controlled as a function of the received supply voltage level, which is taken to be dependent on the length of the communication medium. A low voltage thus usually results from a high attenuation and causes a high amplification.

Within the scope of the invention, the voltage received by the telephone is independent of the length of the first communication medium. The level of the supply voltage supplied by the converter may, in particular, be the maximum supply voltage of the telephone, thus causing a minimal amplification of the voice signal.

In order to correct this problem, the converter should be equipped with a module for determining the power losses on the first communication medium, which connects the module to the transmitter element. For example, this module comprises means for measuring the received power, the losses being deductible on the basis of the knowledge of the transmitted power.

The converter must also have a controllable voltage-level output, which is intended for powering the telephone and the voltage level of which is determined as a function of the losses measured on the first communication medium.

The length of the first communication medium is thus determined, and the voltage level of the means for powering the telephone T is adjusted so as to be representative of this length. The operation and the nominal powering of the telephone may thus be preserved, while at the same time having a more powerful means for powering the other devices.

Other variations or embodiments are, of course, conceivable.

The various embodiments may, in particular, be combined. The converter may, for example, be disposed in any manner according to the embodiments described with reference to FIG. 1 or 2, and may be suitable for powering one or more devices.

In a variation, the converter is connected to a back-up electric energy source, thus providing additional electric energy in the event of a failure occurring or the electric power signal transmitted by the transmission means of the transmitter element being inadequate.

In a further variation, the converter having wide input ranges delivers an electric power signal that is variable as a function of the nature of the data received, in order to power only the device for processing this data.

In an embodiment of this type, the converter is controlled by management means suitable for identifying the nature of the received data and for controlling the converter so as to cause the generation of an electric power corresponding to the powering of a device for processing the received data.

Advantageously, the management means are also suitable for allowing hierarchisation of the powering means as a function of an order of priority among the various processing devices likely to be simultaneously in operation.

For example, the telephone has to be powered constantly, and the remaining electric power has to be distributed among the various devices as a function of a pre-established order and/or remote management data transmitted by the transmitter element.

Moreover, other elements may be connected directly to the converter, for example a GSM-type wave communication interface or else other types of interface such as ETHERNET or BLUETOOTH interfaces, or any communication interface.

Furthermore, the connection device may incorporate one or more of the elements that it powers, for example the high-speed modem or else either a radio interface modem or a GSM modem.

The connection device is advantageously in the form of a telephone connection console having a plurality of connection plugs, each adapted to a different processing device and supplying both the data and the electric power required for using the device.

For example, the connection device consists of a high-speed radio modem constantly powered solely from the telephone network, thus forming a genuine network terminal, in particular in the case of digital networks such as the GSM or xDSL Network. An embodiment of this type has the advantage of transforming each connection device into an entry point to the network, regardless of the use of the device made by a main user.

In a variation, the connection device may be installed, for direct connection, in locations inaccessible to specific users, so there is only one radio-wave connection interface.

As a function of the embodiments, the processing devices may be powered and the data signals transmitted over a plurality of independent links. It is also possible for the powering and signals to be transmitted over a single link, using appropriate coupling and filtering means.

In the case of the powering of a telephone, in particular, the output of the converter delivering the electric power signal has to be connected to the link conveying the data signal via a filter, in order to prevent the data signals from being overwritten by the converter.

Moreover, the total power transmitted on the communication medium must not exceed the safety standards of the telephone network used. For example, the RTC Network used in France comprises lightning protection means preventing the transmission of a total voltage greater than 400 volts, such that the maximum transmitted voltage should be limited to an AC or DC voltage of approximately ±175 volts, for example.

Furthermore, the electric energy storage means may be used for supplying electric energy to communication devices and devices for processing the received data, but also to other types of device, man/machine interface devices such as loudspeakers, wireless telephones, display screens, etc.

It may therefore be seen that the system according to the invention and the corresponding connection device allow the remote powering of processing devices such as telephones, communication devices, radio interfaces, or any other devices, by supplying an additional electric power relative to the nominal electric power conveyed by the network.

1-19. (canceled)

20. System for the remote powering of at least one data-processing device (T, TIP, MHD) having given power intensity and voltage operating ranges and being connected, via a variable-length communication medium (8), to a transmitter element (2) comprising means (10; 20; 30; 40) for exchanging at least one data signal with a telecommunication network (6), means (12; 22; 32; 41; 42) for transmitting an electric power signal to said at least one device (T, TIP, MHD), which means are suitable for transmitting an electric power signal having an intensity and/or a voltage greater than the maximum power intensity and/or voltage of the corresponding ranges of said at least one processing device (T, TIP, MHD), means (14; 24; 34; 44; 70) for coupling said at least one data signal exchanged with said network (6) to said at least one electric power signal for the transmission thereof, on said communication medium (8), to a connection device (4) of said at least one processing device (T, TIP, MHD), said connection device (4) comprising filtering means (16; 26; 36; 46) suitable for separating said electric power data signals, a power converter (18; 28; 38; 48) having wide intensity and/or voltage input ranges, which converter is inserted on said communication medium (8), between said transmitter element (2) and said data-processing device, for defining a first medium (8a) for communication between said transmitter element (2) and said converter (18; 28; 38; 48) and a second medium (8b) for communication between said converter (18; 28; 38; 48) and said processing device (T, TIP, MHD), said converter (18; 28; 38; 48) being suitable for receiving said electric power signal transmitted by the transmitter element (2) and for delivering an electric power signal having a suitable intensity and voltage to allow for the power losses caused by said second communication medium (8b) in order to supply said at least one processing device (T, TIP, MHD) with power having an intensity and a voltage within its given operating ranges, characterised in that said transmitter element (2) is suitable for transferring at least one signal (RTC) containing analogue voice data mixed at a so-called nominal electric power, said means (42) for transmitting an electric power signal being suitable for transmitting a so-called additional electric power signal, and said filtering means (46) of the connection device (4) delivering a signal containing said analogue voice data, mixed at said nominal electric power, to a telephone device (T) forming the processing device, and another signal, containing said additional electric power, to said converter (48), and in that said system also comprises means (68; 90) for detecting the presence of a data signal on said communication medium (8) so as to reduce the transmission of said additional electric power when a data signal is detected on said communication medium (8), in order to allow the transmission, sequentially over time, of said at least one data signal and said additional electric power.

21. System according to claim 20, characterised in that said converter (18; 28; 38; 48) is inserted on said communication medium (8) between said filtering means (16; 26; 36; 46) of said connection device (4) and said at least one processing device (T, TIP, MHD), to which it is connected directly by said second communication medium (8b).

22. System according to claim 20, characterised in that said transmitter element (2) is suitable for transferring at least one signal (XDSL; VOIP) containing digital data, and in that said filtering means (16; 26; 36) of the connection device (4) deliver at least one signal containing digital data to a high-speed communication device (MHD) forming the processing device and another signal containing said received electric power to said converter (18; 28; 38), which is suitable for powering at least said high-speed communication device (MHD).

23. System according to claim 20, characterised in that said transmitter element (2) and said connection device (4) each comprise a controllable switch module (62, 64) for connection to said communication medium (8), which modules are controlled by said line tap-detection means (68), for respectively switching, in said transmitter element (2), between said at least one data signal and said additional electric power signal and, in said connection device (4), between said data-processing device or devices (T, MHD) and said converter (48), so as to allow, alternately, the transfer, on said communication medium (8), of said at least one data signal to the processing device or devices (T, MHD) or the transfer of said additional electric power signal to said converter (48).

24. System according to claim 23, characterised in that said transmitter element (2) comprises controllable means (72) for simulating a line tap, which means are connected to the output of the data exchange means (40) and to the input of said coupling means (70), which are suitable for not transferring said nominal electric power originating from said transmitter element (2) to said communication medium (8), and in that said connection device (4) comprises a controllable switch module (84) for connecting said converter (48) to said communication medium (8), said line tap-simulation means (72) and said controllable switch (84) being controlled by said line tap-detection means (90) for simulating, in said data transfer network (6), the line tap, and for limiting the electric power circulating on said communication medium (8) during a line tap.

25. System according to claim 20, characterised in that said converter is suitable for directly delivering a plurality of electric power signals, each intended for a different processing device (T, TIP, MHD), each electric power signal having a suitable intensity and voltage to allow for the power losses caused by said second communication medium (8b), in order to supply to each processing device (T, TIP, MHD) power having an intensity and a voltage within its given operating ranges.

26. System according to claim 25, characterised in that it also comprises means for driving said converter, which means are suitable for driving it as a function of the nature of the data supplied by said filtering means for delivering an electric power signal suitable for the device for processing this data.

27. System according to any claim 20, characterised in that said connection device is provided for being connected to at least one processing device selected from a group consisting of a wireless radio-wave communication device (WiFi), a high-speed modem (MHD) and a device for communication with a mobile telephone.

28. Device for connecting to a communication medium (8), with a telecommunication network (6) of at least one processing device (T, MHD, TIP) having given power intensity and voltage operating ranges, the device (4) comprising suitable filtering means (16; 26; 36; 46) for separating at least one data signal and an electric power signal conveyed by said communication medium (8), characterised in that it also comprises a converter (18; 28; 38; 48) having wide intensity and/or voltage input ranges, which converter is suitable for receiving at its input an power signal having an intensity and/or a voltage greater than the maximum power intensity and/or voltage of said at least one processing device (T, TIP, MHD), and for supplying power having an intensity and a voltage within the given operating ranges of said at least one processing device (T, TIP, MHD).

29. Power conversion device inserted on a communication medium (8), between a transmitter element (2) and a data-processing device (T, TIP, MHD), for defining a first communication medium (8a) between said transmitter element (2) and said conversion device, and a second communication medium (8b) between said conversion device and said processing device (T, TIP, MHD), said device being connected to said first communication medium (8a) via a filtering device, in order to separate data and electric power signals, and being connected to said second communication medium (8b) by a coupling unit, in order to transmit said data signals and a suitable electric power signal, characterised in that it comprises a converter (18; 28; 38; 48) having wide intensity and/or voltage input ranges, between said filtering unit (16a) and said coupling unit (14a), which converter is suitable for receiving at its input an electric power signal having an intensity and/or voltage greater than the maximum power intensity and/or voltage of said at least one processing device (T, TIP, MHD), and for supplying power having an intensity and a voltage within the given operating ranges of said at least one processing device (T, TIP, MHD).
